(19) United States
(12) Patent Application Publication
(10) Pub. No.: US 2011/0017679 A1
(43) Pub. Date: Jan. 27, 2011

(54) HOME-SCALE WATER AND SANITATION SYSTEM

(76) Inventor: Arthur Louis Zwern, San Jose, CA (US)

Correspondence Address: Stolowitz Ford Cowger LLP, 621 SW Morrison St, Suite 600, Portland, OR, 97205, US

(21) Appl. No.: 12/508,515

(22) Filed: Jul. 23, 2009

(51) Int. Cl. C02F 9/10

(52) U.S. Cl. 210/767; 210/175; 126/628

(57) ABSTRACT

A water processing system includes a water collector to deliver unpurified water to a first container, and a water purifier to purify the water in a second container. A thermal scavenging device extracts heat from a thermal source to heat the purified water, wherein the heated water is stored in a third container, and wherein the first, second, and third containers comprise identically sized containers.

### CROSS-REFERENCE TO RELATED APPLICATIONS

This application is related by subject matter to the following three U.S. non-provisional patent applications, entitled: PASSIVE HEATING, COOLING, AND VENTILATION SYSTEM; INTEGRATED OFF-GRID THERMAL APPLIANCE; and MULTI-FUNCTION VENTILATION AND ELECTRICAL SYSTEM; which were all filed on Jul. 23, 2009, and which are incorporated by reference in their entirety. This application is further related by subject matter to PCT application entitled INTEGRATED INFRASTRUCTURE FOR SUSTAINABLE LIVING, filed on Jul. 23, 2009 and also incorporated by reference in its entirety.

### BACKGROUND

The lives of refugees, disaster victims, homeless and the poor throughout the world have been improved by low-cost mass-produced housing. Such housing may be rapidly deployed on a large scale, or on an individual basis such as at a campground, festival or as a personal living quarters. The developed world often takes for granted utilities and other infrastructures put in place to sustain its large population densities. When access to clean water, sanitation, cooking heat, electrical lighting, etc. is compromised by natural or man-made events, it can be difficult to restore these services without a massive scale effort. This can result in a significant delay for restoring these basic services for the individuals involved, with large health and safety impacts even if they have basic sheltering provided by low-cost mass-produced housing and community structures.

In some developing world or rural regions, where access to utilities may be limited or unavailable, such structures may in fact become a permanent residence or other inhabitable structure, where a chronic lack of utilities may lead to exposure, disease, and mortality as well as conflict over scarce resources. Similarly, many people living in developed countries want to reduce their environmental footprint.

Passive utility provisioning and waste disposal systems integrated into low-cost mass-produced housing would provide the ability to deliver a rapid response to these types of crises and situations, reduce the need for costly ongoing support of aid recipients, and reduce the environmental cost of temporary sheltering. The goal of low-cost mass-produced housing is to extract maximum human survival and comfort per dollar from the environment while producing as little waste or pollution as possible. The structures should require a low initial cost, low operating cost, low need for external resources, and be easily scalable to the user needs.

By eliminating the complexity of modern urban infrastructures, we can strive to start with an empty expanse of unspoiled terrain, rapidly inhabit it for short or long term without the need for purchasing scarce resources, move away, and leave no trace on the land, air, or water. A complete solution that achieves all of these goals while enabling human survival and conveniences has so far proven elusive.

The embodiments described herein address these and other concerns.

### SUMMARY

A water processing system is disclosed herein, comprising a water collector configured to deliver unpurified water to a first container, and a water purifier configured to purify the water in a second container. The system further comprises a thermal scavenging device configured to extract heat from a thermal source to heat the purified water, wherein the heated water is stored in a third container, and wherein the first, second, and third containers comprise identically sized containers.

A method is disclosed herein, comprising collecting unpurified water in a first container purifying the water in a second container, and extracting heat from a thermal source to heat the purified water in a third container. The first, second, and third containers comprise identically sized containers.

### BRIEF DESCRIPTION OF THE DRAWINGS

FIG. 1 illustrates a passive room and cooking ventilator used for a building.

FIG. 2A illustrates a turbine solar chimney trombe.

FIG. 2B illustrates an example heat exchanger used with the turbine solar chimney trombe of FIG. 2A.

FIG. 3A illustrates an example solar concentrator.

FIG. 3B illustrates the solar concentrator of FIG. 3A secured to the top of a grill rack.

FIG. 4A illustrates an off-grid thermal appliance.

FIG. 4B illustrates an example solar collector.

FIG. 4C illustrates a further example of a solar collector.

FIG. 5 illustrates a state table state diagram for an off-grid thermal appliance.

FIG. 6 illustrates an example of a complete integrated cooking, heating, and ventilation subsystem.

FIG. 7 illustrates an example electrified turbine ventilator.

FIG. 8 illustrates an example integrated electrical subsystem operable with the electrified turbine ventilator of FIG. 7.

FIG. 9 illustrates an example off-grid water subsystem.

FIG. 10 illustrates an example water transporter operable with the off-grid water subsystem of FIG. 9.

### DETAILED DESCRIPTION

Described herein is an integrated set of passive natural resource subsystems that work together to provide a complete set of utilities for human survival and comfort using what nature provides. The resulting family-scale passive utility grid harnesses solar energy, wind, geo-cooling, gravity, convection, and rain or river water along with a minimized quantity of fossil fuel for additional thermal energy, and delivers ventilation, heating, cooling, cooking, fire ignition, exhaust ventilation, electric lighting and accessories, a complete subsystem for collecting, purifying, storing, dispensing, and reusing water, and human sanitation, in tightly integrated fashion. Novel aspects of each subsystem will be described, followed by its integration into preceding subsystems and novel features of such integration.

Passive Room and Cooking Ventilator

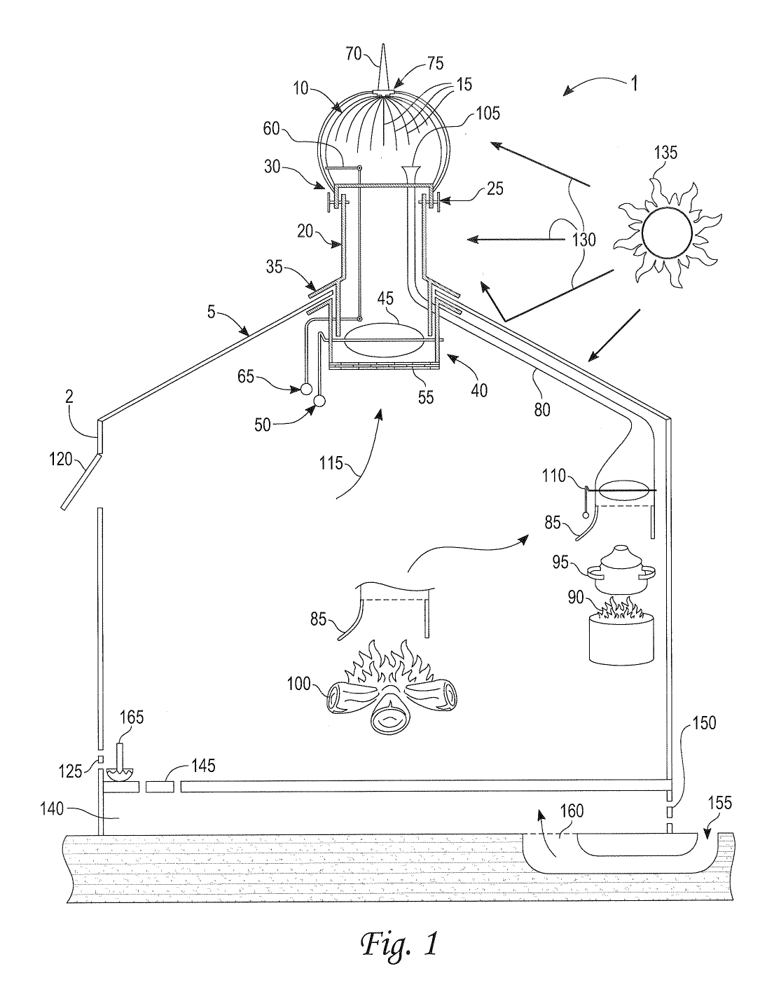

FIG. 1 shows passive room and cooking ventilator 1 used for a human shelter 2 or similar structure containing a sloped or peaked roof 5 and where air from the sheltered area can flow freely to inside the highest point of roof 5. A ventilation turbine 10 containing multiple spinning blades 15 such as used for attic venting is located at or near the highest point on roof 5. In one embodiment, the roof 5 is sloped down in all directions from one location, such as the center of a yurt as shown. A roof slope and wall below increase wind speed at the location of turbine 10, while a directionally uniform slope yields similar wind response regardless of wind direction.

Turbine 10 is held above the roof surface by chimney 20 and secured to chimney 20 by inserting screws 25 through cowl 30 on turbine 10 and into chimney 20, or using any other convenient attachment means. Chimney 20 is positioned on roof 5 via a hole in roof 5, and prevents water intrusion via flashing 35 which also distributes its weight about the roof. Chimney 20 is then secured to plenum 40 via additional screws, snap fit, or other fasteners inside the structure (not shown). Plenum 40 contains an air adjustment means such as a baffle 45 with a flow adjuster 50 to control it. A ceiling vent 55 cosmetically finishes the interior of plenum 40, and ceiling vent 55 may contain an air/insect filter, which may also be located inside turbine 10 as will be later shown. Turbine 10 also may contain a mechanical brake 60, which contains a control linkage 65 to enable limitation of rotation during high winds. Since turbine 10 is at the highest point on the roof, it contains a lightning rod 70 located above an upper bearing 75 and a cable (not shown) from stationary lightning rod 70 to earth ground.

In operation, the wind spins turbine 10, which creates reduced air pressure inside shelter 2 and pulls air 115 out of the highest point in the interior of the structure through plenum 40 via ceiling vent 55. The ventilating flow can be quite significant even in light winds, and once spinning, turbine 10 acts as a flywheel, continuing to spin while buffering the effects of wind gusts, downdrafts, and calms. In addition, whenever air inside shelter 2 is warmer than the air outside turbine 10, air 115 will also rise and exit via turbine 10, increasing net air flow and additionally spinning turbine 10, although temperature differences have less air flow impact than the wind does. In cold weather, baffle 45 may be closed to retain warm air inside the shelter 2, while in warm weather baffle 45 may be opened to exhaust warm air. The warm air is replaced by cooler air from a window 120, or from an inlet vent 125, located near the cooler ground.

Additional turbine motion and ventilation may be enhanced using the solar chimney effect, wherein turbine 10 and chimney 20) are made black and heat absorbent. Solar radiation 130 from the sun 135 impinges on turbine 10 and chimney 20 directly, as well as when reflected from roof 5. This causes air inside chimney 20 to warm up, spinning turbine 10 and exhausting air 115 from shelter 2.

Where shelter 2 contains a basement 140 or other raised floor, increased cooling may be achieved using a floor inlet 145 combined with a basement inlet 150 on the shaded side of the structure, which cools incoming air as it flows over the permanently shaded ground under the shelter 2. Where terrain permits, even greater air cooling may be achieved using a qanat inlet 155 that pulls air in from a shaded place near shelter 2, cools air further underground, and releases it into basement 140 at underground inlet 160. In many climates, a swamp cooling effect may also be achieved by adding moisture 165 at any air inlet 120, 125, 145, 150, 155, or 160. Ideally, such moisture 165 exists naturally underground between qanat inlet 155 and underground inlet 160.

A key element of passive room and cooking ventilator 1 is a secondary flue 80 that leads from a vent hood 85 above a cooking stove 90 and pot 95 or an open fire 100 to an outlet port 105 inside the spinning turbine 10. As will be later described, outlet port 105 is configured to avoid fouling upper bearing 75 or other bearings within turbine 10 while opening within the low-pressure area generated by turbine 10, which draws air or fumes up from vent hood 85 through flue 80 and out of the structure via turbine 10. A flue controller 110 such as a baffle closes flue 80 when no heat is being produced. Hot fumes from flue 80 will additionally rotate turbine 10, assisting air removal from shelter 2.

In addition to general room ventilation, the combination of turbine 10, chimney 20, plenum 40, hood 85, flue 80, and outlet port 105 enable reduced fuel use, and comprise a natural solution to the problem of lung cancer in developing nations as a result of cooking over open fires inside structures. Typically, even with a flue and chimney, it can be challenging to get heat-driven exhaust of flame products moving soon enough and completely enough to achieve efficient fuel ignition or overcome smoke diffusion and subsequent inhalation. In FIG. 1, a low pressure zone from the combination turbine and chimney effects can be located immediately above a flame source and may begin operating prior to flame ignition, providing the functionality of a powered vent hood for users without electrical power This not only exhausts fire and cooking fumes efficiently, but also pulls fresh air into the combustion area where stove 90 or open fire 100 is operating. This harnesses the wind to provide a suction-driven bellows effect to ensure sufficient air for complete combustion in the manner of the rocket stove, which can reduce carbon fuel use 75% or more while using agricultural waste as fuel. The use of a wind-driven turbine to ventilate a living space and independently drive cooking air pressure and flows thus addresses multiple problems in off-grid survival in an integrated and passive manner.

Turbine Solar Chimney Trombe and Solar Heating Integration

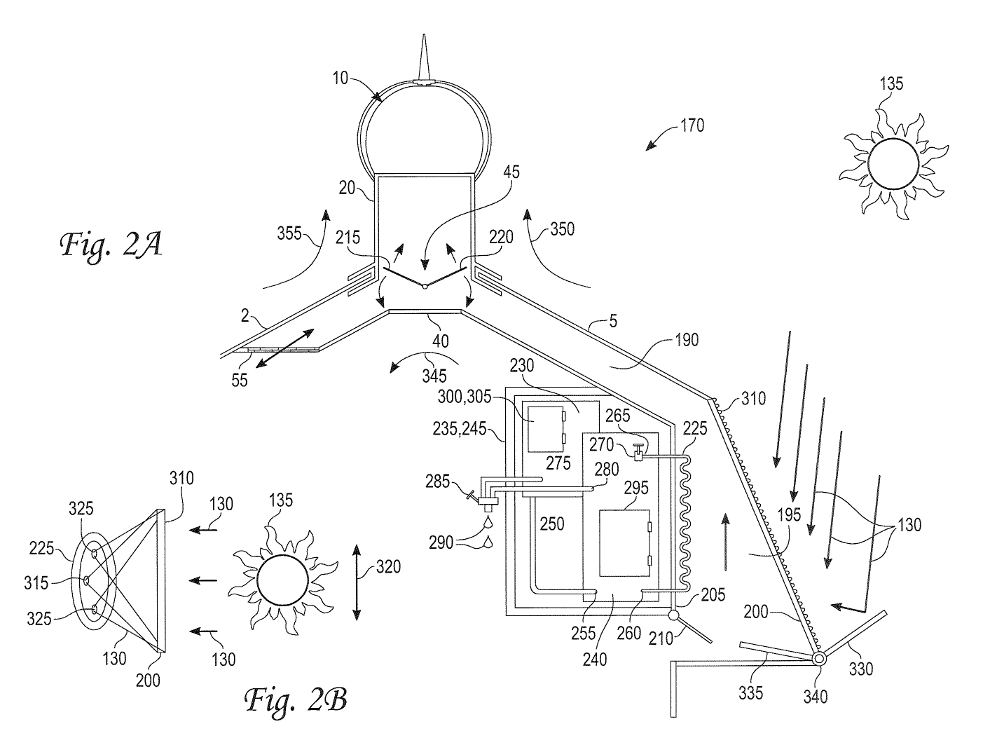

FIG. 2A illustrates several additional aspects that extend passive room and cooking ventilator 1 described in FIG. 1 into turbine solar chimney trombe 170, with previously described details such as the flue 80 and all other cooking-related aspects omitted for clarity. These additional aspects include integrating a trombe wall or solar ventilator with the turbine 10 and chimney 20 to provide additional ventilation benefits, novel solar collection features in the trombe wall approach that concentrate solar heat to enable heating and purifying water in addition to its air movement functions, and additional means to heat and cool the interior of shelter 2 using heated and cooled water.

In FIG. 2A, Plenum 40 is enhanced to contain three primary inlet/outlet directions for air rather than two as shown in FIG. 1. Ceiling vent 55 and opening to chimney 20 are as previously described, while a new trombe chimney 190 is added to connect a trombe wall 195 to the chimney 20. Trombe chimney 190 is shown as a vent duct inside the shelter 2 in FIG. 2A, and in such a configuration, trombe chimney 190 would be insulated from the interior space of shelter 2, uninsulated at the roof 5 surface, and painted black on roof surface 5 to capture solar radiation 130. Alternatively, trombe chimney 190 may be implemented as a blackened vent duct located on the exterior surface of roof 5 without any loss of generality. In either case, trombe chimney 190 captures additional heat into the air flowing upwards within it to assist rotation of turbine 10. The trombe wall 195 may also be referred to as a solar ventilator.

Trombe wall 195 may contain various elements of trombe walls and solar chimneys, including a transparent window 200, a black painted heat absorbing surface 205 that absorbs heat from the sun 135 to serve as a heat bank and help heat the air contained within Trombe wall 195, an adjustable lower room vent 210, and an upper means for exhausting heated air or delivering it to the interior space, which means may be an opening, turbine 10, or ceiling vent 55.

In a trombe wall used for heating an interior space on cold sunny days, trombe wall 195 is closed to the exterior environment at the bottom and at the top. Solar radiation 130 passing through transparent window 200 heats air inside the trombe wall 195, which causes the air inside to rise. Air from inside shelter 2 is pulled into the trombe wall 195 via lower room vent 210, is heated in trombe wall 195, and re-enters shelter 2 via an upper room vent, in this case ceiling vent 55 after taking advantage of extra heating from trombe chimney 190 but no assistance from turbine 10. This return air path is designated with airflow arrow 345.

In a trombe wall as used to provide cooling ventilation on hot sunny days, the solar chimney method is applied as follows: air from inside shelter 2 is similarly pulled into trombe wall 195 via lower room vent 210 and heated in trombe wall 195, but instead of re-circulating the heated air into the interior space via an upper vent such as ceiling vent 55, the heated air is released to the exterior environment via a vent at the roof, including turbine 10, to provide additional assistance. As the heated air rises and exits, it creates low pressure inside the shelter 2, which pulls cooler air from other openings, such as any air inlet 120, 125, 145, 150, 155, or 160. This integrates passive wind and sun powered ventilation, as designated by air flow arrow 350.

The addition of a passive turbine 10 and associated components previously described significantly improves air flow through trombe wall and solar chimney configurations such as the air heating elements here including trombe wall 195, trombe chimney 190, chimney 20, and turbine 10, without the need for an electrically powered air moving fan.

The combination of turbine 10 with trombe wall 195 and the solar chimney effects of trombe wall 195, trombe chimney 190, chimney 20, and turbine 10 enable additional 4-way functionality not known in trombe walls or solar chimneys. In a first mode of operation, Plenum 40 contains a baffle 45 that is in this case bifurcated so that the baffle 45 contains two sections, a room side baffle 215 and a chimney side baffle 220. Each such baffle 215 and 220 may be independently controlled. With both baffles in the upwards positions as shown in FIG. 2A, air from shelter 2 flows into trombe wall 195 via lower room vent 210, is heated within trombe wall 195 and trombe chimney 190, and is forced back into shelter 2 via ceiling vent 55 as depicted by airflow arrow 345. This provides the trombe wall room heating effect on cold sunny winter days, and if chimney side baffle 220 allows a small amount of leakage between trombe chimney 190 and turbine 10, then turbine 10 can still help drive air flow. This enables the wind and sun to combine in driving trombe wall operation. In addition, the same setting may be used to heat the room on cold nights when a stove 90 or open fire 100 is creating heat, as flue 80 from FIG. 1 may be routed inside trombe chimney 190 to heat the air inside it and thus drive convective flow back into shelter 2, while flue 80 exhausts to the exterior via outlet port 105 and turbine 10.

In a second mode of operation, if room side baffle 215 remains in the upward position shown and chimney side baffle 220 is adjusted downwards to open trombe chimney 190 to turbine 10 but close trombe chimney 190 to ceiling vent 55 (FIG. 1), the effect is a wind-assisted solar chimney that provides cooling ventilation powered by the wind and the sun, removing air from shelter 2 via lower room vent 210 and pulling cool air into shelter 2 via any inlet 120, 125, 145, 150, 155, or 160 (FIG. 1) as depicted by airflow arrow 350.

In a third mode of operation, if room side baffle 215 is in the downwards position while chimney side baffle is in the upwards position, the wind-assisted room air exhaust functions described in FIG. 1 are achieved as designated by air flow arrow 355. In a fourth mode of operation, if both room side baffle 215 and chimney side baffle 220 are in the downward positions, rotation of turbine 10 will simultaneously provide the shelter ventilation functions of passive room and cooking ventilator 1, wind-assisted trombe wall operation, and wind-assisted solar chimney operation as designated by air flow arrows 350 and 355 together. It should be understood that there are various intermediate adjustments of room side baffle 210 and chimney side baffle 215 that may be used to optimize operation of the various functions available, and that by integrating turbine 10 with trombe chimney 190 and trombe wall 195 as described, a useful ventilation, room heating, and room cooling method is enabled for a wide variety of climates and weather conditions. It should similarly be understood that a synergistic integration between these benefits and the cooking benefits of FIG. 1 may be readily achieved.

Water Heating, Thermal Banking, and Gravity Dispensing Integration

FIG. 2A also illustrates how the functions of water heating and thermal banking may be integrated within turbine solar chimney trombe 170. The trombe wall may be used to heat water by placing water within the heated area of trombe wall 195, depicted via a liquid/air heat exchanger 225. A convective water heating, thermal banking, and gravity dispensing system for water is integrated around heat exchanger 225 as follows.

A cold water tank 230 contained within a thermally insulated cold chamber 235 contains cold water, and a hot water tank 240 contained within a thermally insulated hot chamber 245 contains water being heated and/or maintained hot (the dividing insulation between cold chamber 235 and hot chamber 245 is omitted in FIG. 2A for clarity). Cold tank 230 contains a cold tank outlet 250 near its bottom that enables water to flow into hot tank 240 via hot tank inlet 255. Further, cooler water near the bottom of hot tank is allowed to flow into heat exchanger 225 via heat exchanger inlet 260, where it is heated by trombe wall 195, rises via convective flow, and returns near the top of hot tank 240 via hot water return 265, which is shown in FIG. 2A with a heat exchanger valve 270. Heat exchanger valve 270 shuts down the convective flow to prevent heat loss whenever trombe wall 195 is not providing heat, such as at night.

To dispense water, cold tank 230 contains a cold water outlet 275, and hot tank 240 contains a hot water outlet 280 in the upper portion of hot tank 240 where the water is warmer. A water tap 285 that may be configured for washing, showers, or other purposes mixes the hot and cold water and dispenses potable temperate water 290. If desired for additional dispensing pressure or because tap 285 is higher than cold tank 230 or hot tank 240, tap 285 may also contain a simple hand pump.

As long as the water level in the cold water tank 230 is higher than the water level in hot water tank 240, then whenever water is dispensed by water tap 285, gravity will force water to flow from the bottom of cold tank 230 via cold tank outlet 250 to hot tank inlet 255, where the cold water becomes available to be heated. This gravity fed process also helps ensure that hot tank 240 and its associated heat exchanger 225 remain full and operational. In practice, cold tank 230 would generally be located higher than hot tank 240 to facilitate gravitational water pressure.

To provide thermal banking for heating and cooling the air within shelter 2, hot chamber 240 contains a heating door 295, which when opened to the interior space of shelter 2 allows heat to radiate, conduct, and be convected from the water tank into the air in the interior space, thus heating it. Similarly, cold chamber 245 contains two doors, an interior cooling door 300 that opens to the interior of shelter 2 and an exterior cooling door 305 that opens to the exterior (hidden in FIG. 2A by 300). To cool the water in cold tank 230, exterior cooling door 305 is opened during cold weather and at night to allow heat in the water to escape to the exterior environment, while interior cooling door 300 is closed. To cool the interior space, exterior cooling door 305 is closed, and interior cooling door 300 is opened to allow heat from inside shelter 2 to be captured by cold tank 230.

FIG. 2A also illustrates additional trombe wall water heating approaches that will now be described. In trombe walls, transparent window 200 may include a sheet of transparent material such as glass, which does not focus infrared solar radiation. This does not impact trombe wall ventilation functionality, but for heating water it is desirable to obtain a much higher water temperature than is possible by transferring heat from unmagnified solar radiation to heat exchanger 225. In one embodiment of a trombe wall 195 optimized for heating water, transparent window 200 contains a focusing surface 310 that may be designed to nominally focus incoming light into a linear beam several times taller than it is wide, and to provide some prismatic aiming capability about the horizontal so that solar radiation 130 coming from near vertical orientations can be redirected towards heat exchanger 225. As the sun goes up and down in the sky, a relatively small linear beam would move up and down along heat exchanger 225. Such a focusing surface 310 may be achieved conveniently via two-dimensional lens variants such as lenticular lenses and Fresnel lenses, which can ignite paper with a handheld size lens or vaporize a penny in seconds with a 1 meter surface area focusing surface.

It is noted that in FIG. 2A, transparent window 200 is shown angled towards the sun 135 to present greater surface area to it, rather than aligned vertically as in some trombe walls. In such a case, heat exchanger 225 could be similarly angled (not shown) or the focusing surface 310 could be segmented or otherwise varied to ensure efficient focusing of solar radiation 130 onto heat exchanger 225.

As shown in FIG. 2B along a vertical axis of heat exchanger 225, focusing surface 310 focuses solar radiation 130 onto a focused area 315 that is much smaller than the width of transparent window 200. This directs more heat per square inch at heat exchanger 225, and thus enables the water within heat exchanger 225 to be heated hotter than the surrounding air within trombe wall 195 without increasing the net amount of heat admitted by transparent window 200.

The position of the sun 135 varies during the course of the day and seasons. In the view of FIG. 2A, as the sun 135 moves up and down in the sky during the day on the side of shelter 2 that contains trombe wall 195, solar radiation 130 continues to impinge on heat exchanger 225 since the vertical dimension of focusing surface 310 is greater than that of heat exchanger 225. Also as shown in FIG. 2B from a top view, solar rays 130 continue to focus on heat exchanger 325 for a range of horizontal sun angles with respect to focusing surface 310, since the horizontal dimension of heat exchanger 325 is greater than the focused area 315. Specifically, as the sun 135 moves in the horizontal direction shown by arrow 320 over the course of a day or during different seasons, focusing surface 310 ensures that focused area 315 remains directed upon heat exchanger 225, as shown at off axis focused areas 325. Focusing surface 310 thus provides an effective solar concentrator for water heating, and a useful integration of same into trombe wall 195.

To increase performance of the trombe wall and solar water heating efficiency, external mirror 330 and internal mirror 335 serve to increase the effective surface area of focusing surface 310, thus delivering more heat to trombe wall 195 and heat exchanger 225 and providing an independent aiming means for concentrating solar radiation 130. Each of external mirror 330 and internal mirror 335 may be adjusted via pivot or hinge 340, and may be combined into a single mirror without loss of generality.

Off-Grid Thermal Appliance and Integration

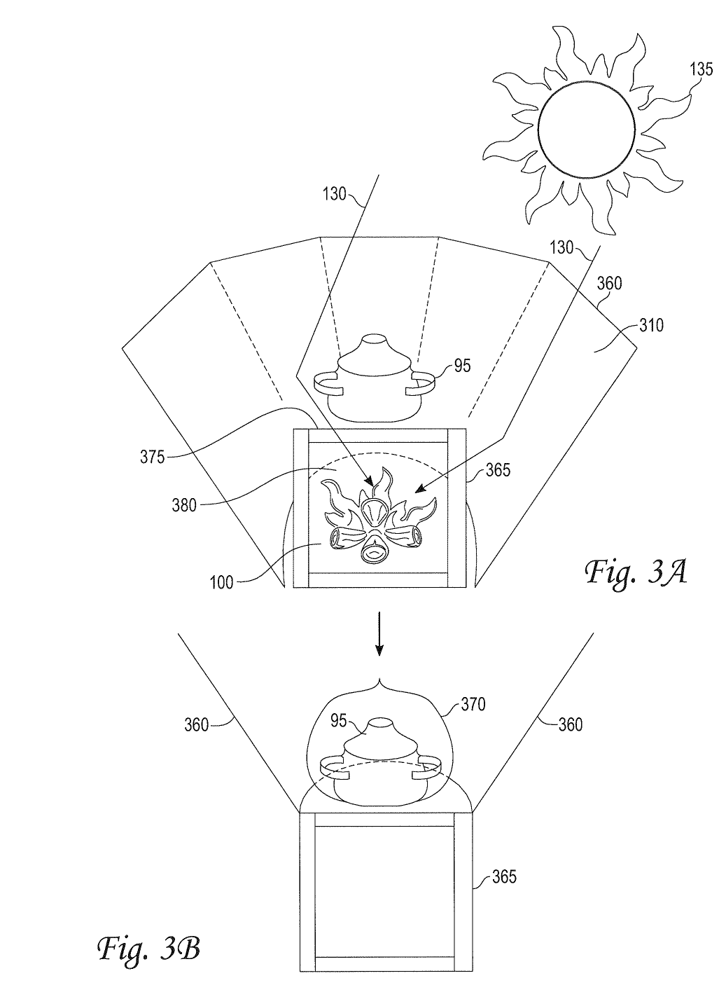

FIG. 3A illustrates a simplified version of a solar concentrator 360 that comprises a focusing surface 310 combined with an open fire 100 which may also be a fueled stove 90. FIG. 3A, solar concentrator 360 is shown as a folding multi-faceted reflective mirrored assembly, although rounded optical surfaces may focus more intensely, and any manner of solar concentrator 360 may be used without loss of generality if it suitably concentrates solar energy. As shown in FIG. 3A, when the solar concentrator 360 is secured to the base of grill rack 365 with a cooking pot 95 above it, a solar concentrator 360 with suitably low optical aberration can focus sufficient solar radiation 130 from the sun 135 to ignite tinder placed in the area of the open fire 100.

Once a fire is ignited solar concentrator 360 may be removed. Alternatively, if solar cooking is desired without carbon fuels, FIG. 3B shows solar concentrator 360 adjusted vertically upwards versus grill rack 365 and pot 95, with solar concentrator 360 secured to the top of grill rack 365. In this configuration, solar cooking can proceed using a pot 95 blackened to absorb heat, contained within an enclosed transparent chamber 370 to retain the heat, such as a high-temperature cooking bag. In addition, open fire 100 or fueled stove 90 below pot 95 can assist the solar process. In one embodiment of such fuel-assisted solar cooking, a more flame-resistant material such as glass would be used for transparent chamber 370.

In one embodiment, the top surface 375 of grill rack 365 may convert between a grill and a metal planar surface that seals the area 380 within the bottom of solar concentrator 360 to force smoke from open fire 100 to vent to the outside of solar concentrator 360 and thus protect the reflective surface of solar concentrator 360. A very small fire 100 or fueled stove 90 such as a gasifier would result in minimal heat loss around solar concentrator 360 and maximum assist to the solar cooking process facilitated by the solar concentrator 360, with minimal fuel use.

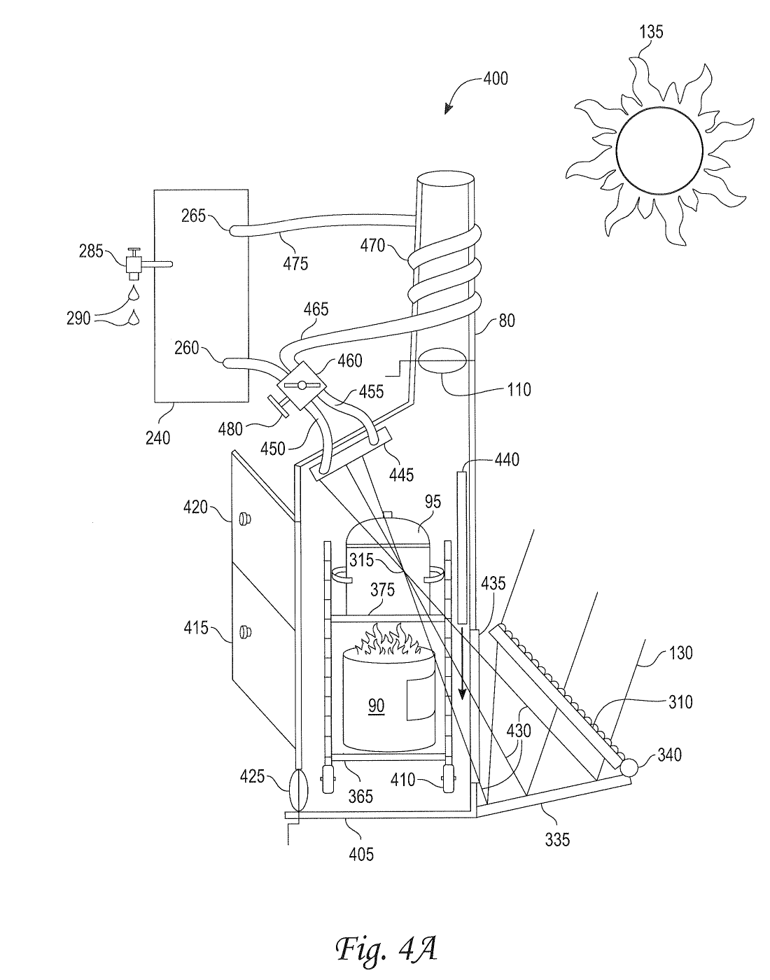

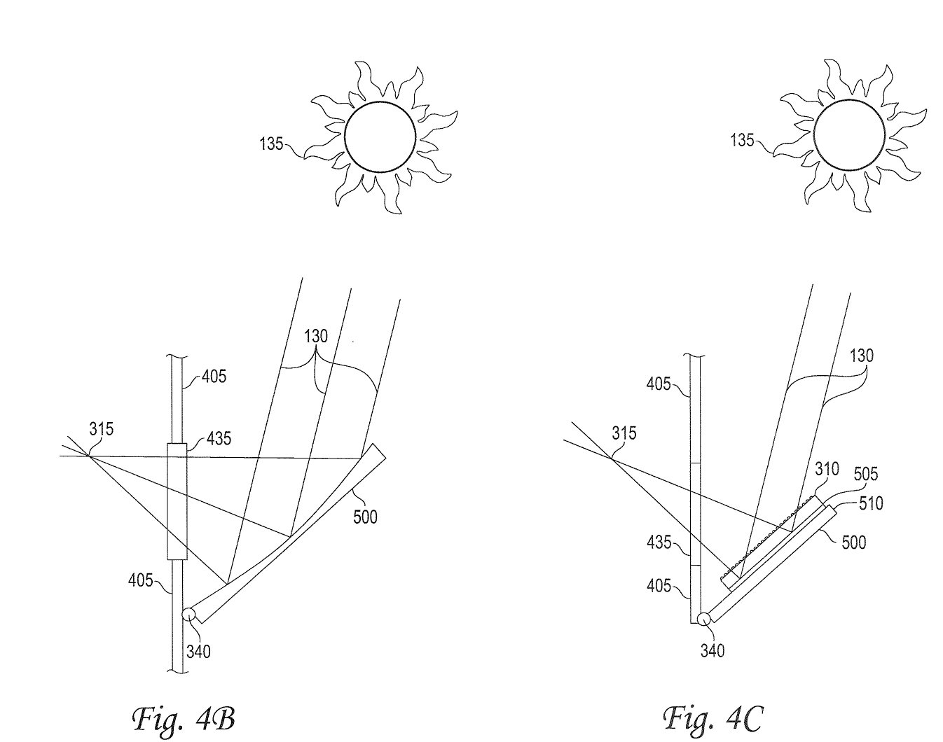

FIG. 4A builds on FIG. 3A and 3B and integrates water heating functions described in FIG. 2A into a complete off-grid thermal appliance 400 that integrates the functions of solar igniter, solar oven, fueled oven, combination solar/fueled oven, solar/fueled water heater, and room heater in a manner that enhances efficiency of the individual functions. The configuration of FIG. 4A may be executed as a standalone appliance, or as will be shown, may be integrated within the passive room and cooking ventilator 1 of FIG. 1 or the more complete turbine solar chimney trombe 195 of FIG. 2A. FIG. 4B and 4C show additional embodiments that achieve the optical properties required for the functionality that will be described for FIG. 4A.

In FIG. 4A, off-grid thermal appliance 400 includes an insulated oven chamber 405 that contains heat and encloses a heat source such as fueled stove 90 or open fire 100, as well as an optional cooking pot 95, and a grill rack 365 that may be moved up and down via grill adjuster 410 to adjust the vertical position of fueled stove 90 or open fire 100. Fire door 415 and oven door 420 provide access to within oven chamber 405 for handling food, fuel, and cleaning, or to allow heat to escape for warming the space around the off-grid thermal appliance 400. Adjustable air input 425 allows cool air in to support fueled cooking or is closed when solar-only functionality is desired. Flue controller 110 is similarly closed for solar-only operation or to retain heat within the oven when not cooking.

Solar radiation 130 from the sun 135 is collected and focused by focusing surface 310 adjustable by a pivot or hinge 340, reflected by internal mirror 335, and is focused to a small focused area 315 within oven chamber 405. To enter oven chamber 405, converging solar radiation 430 passes through thermal window 435 to prevent heat loss from inside oven chamber 405. A retractable, insulated thermal window cover 440 is also shown, which may be used to retain heat inside oven chamber when no solar radiation 130 is available. When solar energy 130 is available, grill adjuster 410 may be used to locate tinder at the small focused area 315, and the tinder will rapidly ignite. If grill adjuster 410 is used to locate cooking pot 95 so that small focused area 315 is within or projected upon cooking pot 95, the food inside cooking pot 95 will be heated. If nothing is placed near the small focused area 315, the converging solar radiation 430 passes through its focal point and diverges again, impinging on cooking heat exchanger 445, which is an embodiment of heat exchanger 225 previously described. In the configuration of FIG. 4A, directing solar energy towards the small focused area 315 in an upwardly manner is beneficial, since heat rises, food may be simultaneously heated from the bottom by solar and fueled heat sources, flames may be ignited while food is above the flame area, and both solar and fueled waste heat rise further to heat exchanger 445.

In FIG. 4A, cooking heat exchanger 445 is a radiator-like air/liquid heat exchanger with high surface emissivity. As a result, collected solar heat may be conducted into and moved away from heat exchanger 445 to limit the heat re-emitted into oven chamber 405. Control over heat removal is accomplished by connecting heat exchanger 445 to hot tank 240 in a similar manner as FIG. 2. First, oven water inlet 450 and oven water outlet 455 are connected to hot tank 240 via loop valve 460. In the open position, loop valve 460 allows convection to move cool water from heat exchanger inlet 260 on hot tank 240 through loop valve 460 and through oven water inlet 450 into heat exchanger 445. There the water is heated by solar rays or excess cooking heat from cooking stove 90, and forced up through oven water outlet 455 back through another path in loop valve 460 where it proceeds through interconnect 465 to flue scavenger 470 which wraps around flue 80 to scavenge additional waste heat from oven chamber 405, and finally re-enters hot return 265 in hot tank 240 via return line 475.

Loop valve 460 may alternatively be adjusted to a closed position via loop valve controller 480. In the closed position, heat exchanger inlet 260 is connected directly and only to interconnect 465, while oven water inlet 450 is connected directly and only to oven water outlet 455. In the closed position, loop valve 460 thus provides for a convective water heating loop using heat captured from flue 80, while simultaneously forcing heat in heat exchanger 445 to remain within it or escape into oven chamber 405. This heats oven chamber 405 and anything within it more quickly, such as for preheating before cooking. It also enables oven chamber 405 to keep cooked food warm longer once solar and fueled cooking ceases.

Since thermal window 435 comprises a small fraction of the spherical space around heat exchanger 445 into which heat can radiate from it, while the inner surface of oven chamber 405 is reflective to reject radiation, most solar radiation 130 impinging on heat exchanger 445 and then emitted, conducted, or convected as heat from heat exchanger 445 will remain within oven chamber 405 where it can be utilized, rather than escaping immediately via flue 80 or thermal window 435. Closing loop valve 460 thus enables pre-heating oven chamber 405 on hot or cold sunny days before initiating cooking, continuing with solar cooking or fueled cooking or both solar and fueled together, and in general, enables the user to assign thermal priority to cooking over water and room heating when desirable for human comfort and fuel conservation. At any time, extra room heating may be accomplished by opening hot tank door 295 (not shown) as described in FIG. 2.

FIG. 4B and FIG. 4C illustrate additional embodiments for concentrating solar radiation 130 using various means of enabling focusing surface 310 for a solar concentrator 360. In FIG. 4B, the focusing surface 310 as well as the functionality of internal mirror 335 of FIG. 4A are combined in one reflective concentrator 500, illustrated as a parabolic surface shape. Reflective concentrator 500 may be adjusted via hinge 340 to aim focused area 315 within oven chamber 405. Since one problem with mirror surfaces is a delicate reflecting surface that is damaged easily by cleaning or dirt, FIG. 4C shows a reflective concentrator 500 comprised of three elements, a focusing surface 310 such as a Fresnel lens, a back mirror 505 consisting of a highly reflective surface, and a backing surface 510 which may be adjusted by a pivot or hinge 340. Solar radiation 130 impinging on focusing surface 310 is converging as it continues to back mirror 505, and is converged further upon exiting through focusing surface 310 on its way towards focused area 315 within oven chamber 405. By sandwiching the mirror 505 between a rugged supporting backing surface 510 and a robust flat refractive focusing surface 310 such as a Fresnel lens, performance and maintainability are ensured. It is noted that in practice, focusing surface 310 may have its optical power elements such as grooves on the side facing back mirror 505 for even easier cleaning of the exterior surfaces. Referring back to FIG. 2A, it is also clear that external mirror 330 or internal mirror 335 or both may be focusing surfaces in the manner of FIG. 4B and 4C.

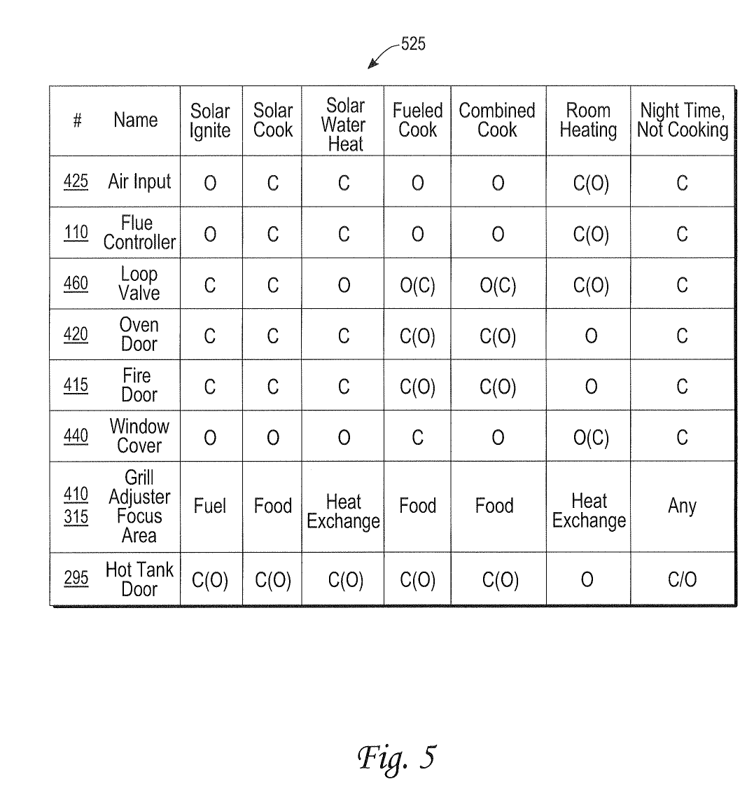

FIG. 5 provides a table 525 illustrating how the key control adjustments described in FIG. 4A may be combined to provide the functions of fuel ignition, fueled cooking, solar cooking, combined solar/fueled cooking, room heating, and water heating. Table 525 summarizes this information in the form of a simple state diagram that defines whether each controllable component within off-grid thermal appliance 400 is open (O) or closed (C) to achieve a given functional result of solar ignition, solar cooking, room heating, etc. In the case of air flow controls such as air input 425 and doors such as oven door 420, “open” denotes allowing maximum air flow, while “closed” denotes allowing minimum air flow. In the case of Loop Valve 460, “open” denotes allowing water to flow around the entire water heating sequence described in FIG. 4A, while “closed” denotes separating the heat exchanger 445 from the remaining components in the water heating sequence. In the case of grill adjuster 410/focus area 315, table 525 denotes the target of the converging solar radiation 430 when grill adjuster 410 is correctly positioned.

Some of the cells in the table include two possible settings, defined as follows. In each case, the first setting is a default, and the alternative setting modifies it. Hot tank door 295 is normally closed except during Room Heating, but may be opened at any time to warm the room during other operations. In the Fueled Cook and Combined Cook columns, the parenthetical settings for oven door 420 and fire door 415 allow heat to escape to the room to heat it during cooking if desired, while loop valve 460 may be closed to retain extra heat within oven chamber 405 instead of giving some up to water. In the room heating column, the first settings for air input 425, flue controller 110, and window cover 440 are for solar operation, which is the default since it uses no carbon fuel. For combined solar/fueled operation air input 425 and flue controller 110 are opened, and for fuel-only heating, window cover 440 is additionally closed. It should be appreciated that some elements such as air input 425 and flue controller 110 may be mechanically linked, or if electric power is available from a battery or other source, any or all of the controls in FIG. 5 and elsewhere herein may be automated.

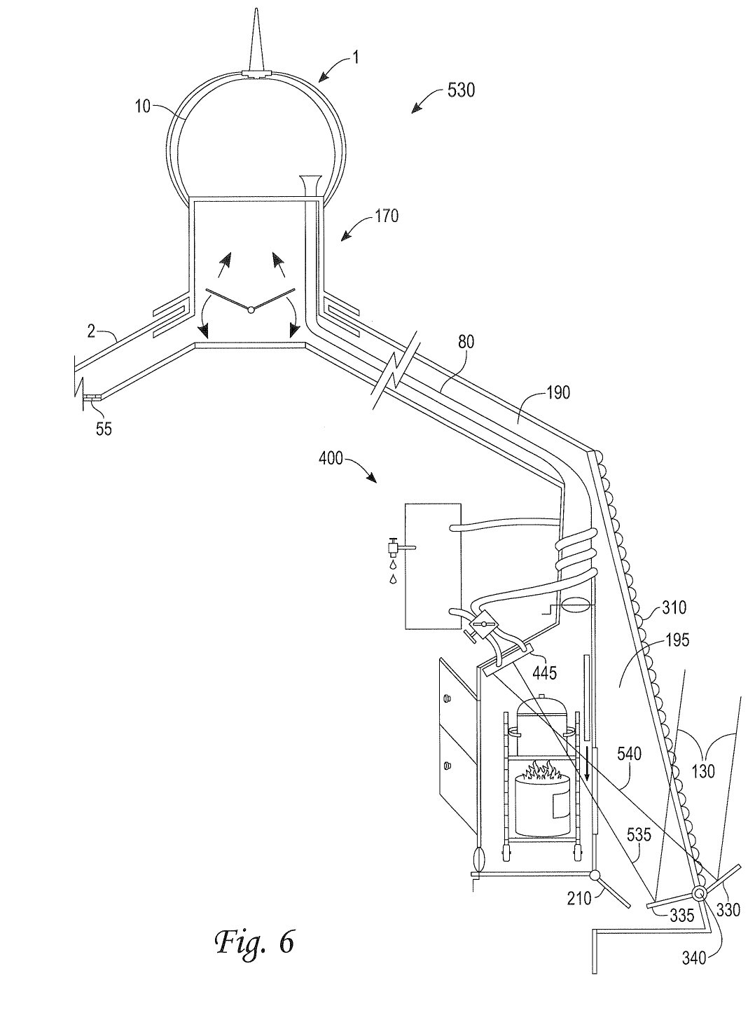

FIG. 6 shows an embodiment of off-grid thermal appliance 400 of FIG. 4A connected to passive room and cooking ventilator 1 of FIG. 1A, together installed within turbine solar chimney trombe 170 of FIG. 2A, to form integrated cooking, heating, and ventilation subsystem 530. In this embodiment all of the various advantages previously described for each subsystem may be combined within a single system. For example, wind-driven suction from turbine 10 drives cooking efficiency and exhaust ventilation for off-grid thermal appliance 400 regardless of ventilation settings. In addition, because flue 80 rises within trombe chimney 190 and heats the air within it whenever a heat source is contained within oven chamber 405, room air coming into trombe wall 195 via lower room vent 210 may be heated and returned to shelter 2 via ceiling vent 55 while combustion fumes are sucked out of the structure by turbine 10, even at night.

The integrated cooking, heating, and ventilation subsystem 530 of FIG. 6 provides a shelter or other structure with a complete thermal energy collection, control, retention, banking, and dispensing solution including flame igniter and water pasteurization/heating, as well as a complete ventilation solution for air heating/cooling and exhausting stoves, composters, or other devices while improving their efficiency. The entire system solution is powered by the sun, wind, gravity, and convection instead of electricity, and greatly minimizes the need for carbon-based fuels whose use increases scarcity, economic burden, health impacts, and pollution. By generating biofuel locally from plants or algae fertilized by human waste products as will be later described, a user's net carbon fuel footprint can be made zero, since all the carbon in the fuel is captured from atmospheric CO2 by the plants or algae and simply returned to the atmosphere when combusted.

Ventilation-Integrated Electrical Subsystem

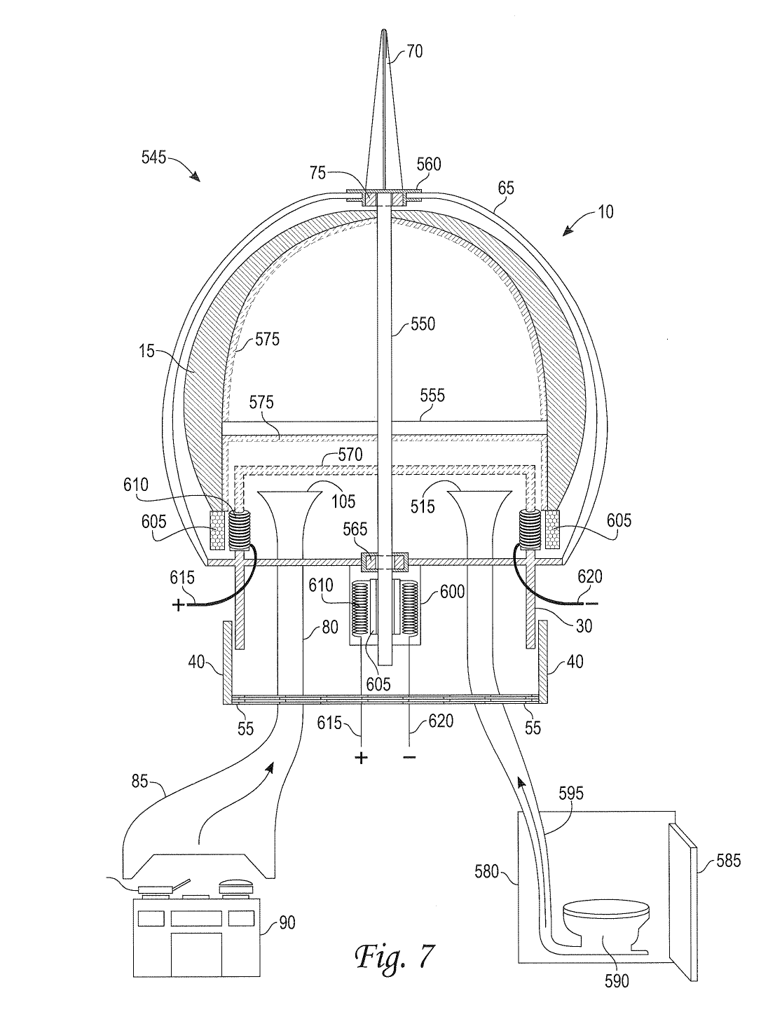

FIG. 7 illustrates additional detail of turbine 10 as used within passive room and cooking thermal ventilator 1 (FIG IA) and turbine solar chimney trombe 170 (FIG. 2A), as well as additional features that integrate bidirectional electric motor components to produce electrical power from wind or heat, or use electrical power to drive ventilation. Some previously described detail of passive room and cooking thermal ventilator 1 and turbine solar chimney trombe is omitted for clarity, including the tri-directional air movement detail of FIG. 2A.

Additional detail of turbine 10 in FIG. 7 includes turbine axle 550 about which turbine blades 15 spin and are connected to turbine axle 550 at the top and via brace 555, as well as upper bearing 75 within insulated bearing housing 560, and lower bearing 565 which together contain turbine axle 550 and allow it to spin. Insulated bearing housing 560 is insulated to electrically isolate lightning rod 70 from the remainder of shelter 2, and in use lightning rod 70 would be connected to earth ground via a ground cable (not shown) secured to stationary outer frame 65 and then running down to a conductive ground anchor (similarly not shown). Insulated bearing housing 560 may also seal the bearing against combustion products from outlet port 515.

FIG. 7 also shows additional detail for alternate embodiments of a pest screen to prevent insects and other small pests from entering shelter 2 between blades 15 of turbine 10. Fixed pest screen 570 is a screened mesh that completely fills a roughly planar area that completely encloses cowl 30 just above the top of outlet ports 105 and 515, and which contains a central opening to allow turbine axle 550 to penetrate it. Alternative embodiments of fixed pest screen 570 include a spinning pest screen 575 secured to brace 555 and the lower insides of blades 15, and a spinning full screen 575 secured completely about the inside envelope of blades 15. The latter embodiment requires more mesh material, but completely prevents pests from entering anywhere within the envelope of turbine 10. It may be appreciated that spinning full screen 575 may form any shape between the curved and horizontal envelopes shown.

FIG. 7 also shows additional detail of turbine 10 connected to two secondary exhaust sources in the manner of passive room and cooking ventilator 1. In addition to a cooking exhaust process connecting stove 90 to outlet port 105 via vent hood 85 and flue 80, a toilet 580 with a toilet door 585 and a composting potty 590 is connected to turbine 10 in a similar manner to flame sources via composter flue 595 and outlet port 515. This enables wind-driven rotation of turbine 10 to exhaust fumes and scents from composting potty 590 to the exterior, which is a key requirement in human waste composting systems. In addition, any heat sources within shelter 2 that cause turbine 10 to rotate will additionally pull fumes from composting potty 590. To provide heat for composting, toilet 580 may share a solar collector such as trombe wall 195 with other subsystems, or may use its own solar collector. In addition, pipes containing water heated as earlier described (not shown) may be circulated within composting potty 590 to provide heat.

In addition to the additional detail described, FIG. 7 illustrates an electrified turbine ventilator 545 comprising a combination of wind driven ventilation and electric power generation, whereby rotating permanent magnets within wire coils may be used to electrify turbine 10. In a first embodiment, a generator 600 is connected to turbine axle 550 causing magnets 605 contained within generator 600 to rotate within coils 610 contained within generator 600. In a further embodiment, coils 610 are attached to cowl 30 in a manner that places them close to blades 15, and several or all of blades 15 contain magnets 605 rotating past coils 610. Wind-driven rotation of turbine 10 produces a direct electrical current between positive turbine lead 615 and negative turbine lead 620. This electrical current may be used to perform electrical work or stored in a battery for later use. DC motors and DC electrical generators are both comprised of spinning magnets and stationary coils, and are equivalent constructs. Therefore, in addition to enabling power generation from wind in a passive turbine ventilation system, magnets 605 and coils 610 also enable use of turbine 10 as a powered ventilation fan driven by electrical power from a battery or other source.

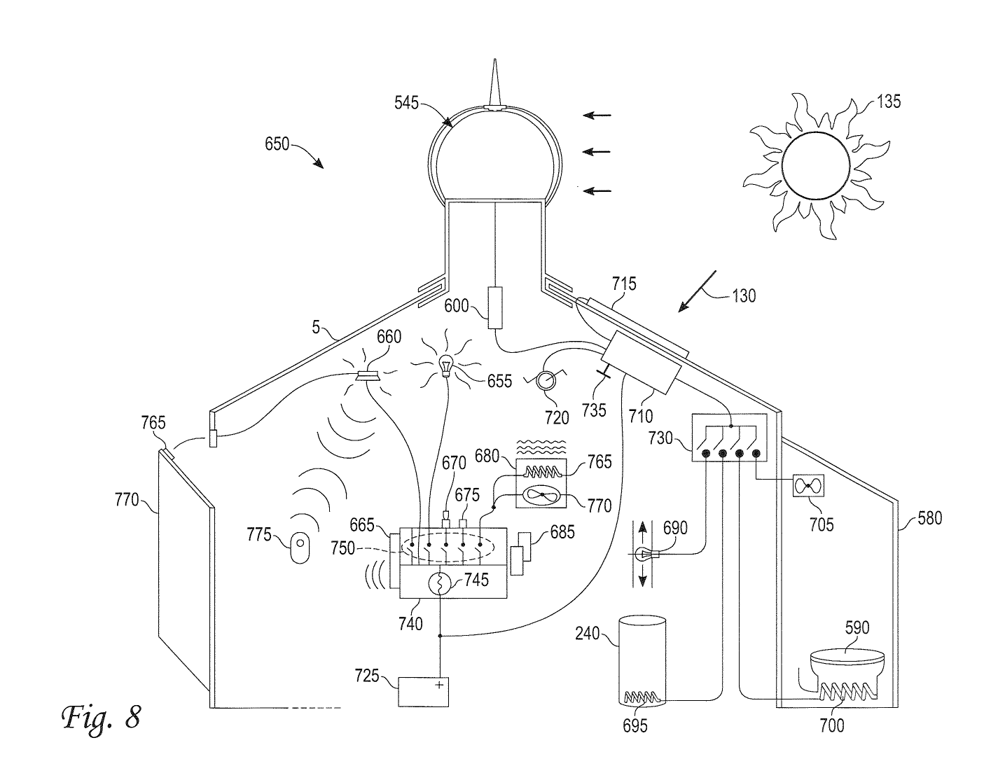

FIG. 8 illustrates electrified turbine ventilator 545 contained in a complete integrated electrical subsystem 650 that integrates with many of the previously described subsystems as will be described. Electrical subsystem 650 integrates collection of electrical energy from multiple sources, prevents waste, and powers a multiplicity of optional electrical devices that may include electrified turbine ventilator 545, low-energy LED lights 655, security/fire alarm 660, radio 665, lighter 670, electronic device charger 675, gasifier stove 680, battery charger 685, UV sanitizing LED 690, water heating element 695 for hot tank 240 or other uses such as boiling water, composter heater 700, fan 705 for assisted ventilation of composter 590 or any other purpose, or any other suitably low-power direct current electrical accessory.

In FIG. 8, generator 600 of electrified turbine ventilator 545 is connected to directional charge controller 710, which may also accept electrical power input from solar panel 715 and/or manual crank 665. Manual crank 720 contains a generator such as generator 600 from electrified turbine ventilator 545 temporarily removed. Charge controller 710 performs several functions. One function is preventing overcharging of battery 725, which some charge controllers for solar cells achieve by sensing the level of battery 725 and opening the circuit between the battery and the solar cell to prevent current flow if the battery is fully charged. Charge controllers for wind devices may dump excess wind power into a waste resistor since removal of an electrical load removes a mechanical rotational load on the turbine itself, which can result in over speed conditions. In survival conditions, neither approach to avoiding battery overcharging is optimal, since they waste available energy production that could be utilized.

The embodiment of charge controller 710 in FIG. 8 simultaneously avoids battery overcharging and energy waste by utilizing excess energy for a variety of purposes, through shunting excess current from electrified turbine ventilator 545, solar panel 715, and manual crank 720 to priority selector 730 whenever the battery is fully charged. Priority selector 730 allows a user to select between various uses of excess electrical power, including UV sanitizing LED 690, water heating element 695, composter heater 700, and fan 705, although in practice any background accessory might be selectable and one or the other would always be selected, such as by making priority selector 730 a rotary switch.

For powered rotation of turbine 10, directional charge controller 710 performs an additional function to electrically disconnect generator 600 from the battery charge sensing of charge controller 710, and instead connect generator 600 to battery 725 via a user-operated bidirectional controller 735. Bidirectional controller 735 may be a potentiometer with a rotating knob, wired so that there is a center detent position connecting generator 600 to the battery sensing and charge control circuitry, and so that as bidirectional controller 735 is turned in either direction from center, one polarity or the other is applied from battery 725 to generator 600 positive turbine lead 615 and negative turbine lead 620. Doing so allows the user to turn turbine 10 in either direction at adjustable speed using power from battery 725. As should be evident from preceding discussions, electrically rotating turbine 10 in the same direction as the wind nominally turns it will move air in all the ways previously described. Electrically rotating turbine 10 in the opposite direction by changing the polarity of electrical current at positive turbine lead 615 and negative turbine lead 620 will force outside air from the roof peak into the structure.

While forcibly moving air from the exterior via electrified turbine ventilator 545 in this manner would rarely benefit a complete implementation of turbine solar chimney trombe 170 and integrated electrical system 650, it can improve comfort under some environmental conditions, such as warm, cloudy, still mornings or nights. In addition, this reversible operation provides important functionality in embodiments where the passive room and cooking ventilator 1 of FIG. 1 is combined with integrated electrical system 650, but does not include additional components of turbine solar chimney trombe 170 or off-grid thermal appliance 400.

In FIG. 8, battery 725 is additionally connected to power distribution panel 740, which contains various components for controlling electrical power and may physically contain directional charge controller 710 and priority selector 730 for user convenience, although they are shown separate in FIG. 8 for clarity. Electrical control components may include fuses or breakers 745 to protect electrical components, as well as electrical switches 750 which are connected to various electrical loads previously described, such as lights 655 and security alarm 660. An inverter (not shown) for powering alternating current devices may also be connected.

An example benefit of this integration is powering a gasifier heater 765 and gasifier fan 770. Conventional gasifiers for off-grid use are standalone units that require complexity because they need energy to heat wood thereby releasing volatile compounds to initiate ignition, and a fan to move the volatiles into a combustion area and remove combustion products. The result is far less wood use and dangerous fumes, but the fan and heater each require battery power, and the battery in turn requires a small electrical generator 600 or other means to generate electrical energy from rising heat to recharge the batteries. In FIG. 1 it can be seen that the ventilating functions are here provided by turbine 10. In FIG. 6 it can be seen that the thermal assistance function may be here provided by the sun. In FIG. 8 it can be seen that thermal and air movement functions are here provided even in the absence of sun or wind, and turbine 10 can perform the function of gasifier fan 770. By eliminating most of the complexity of gasifier stove 680 in favor of a passive home-scale energy grid, gasifier cost is reduced, gasifiers for use within integrated electrical system 650 can be made locally in developing nations more easily, the gasifier and other system components are less failure-prone, and overall system cost plus maintenance are both reduced.

Additionally, security/fire alarm 660 is a smoke sensor and/or carbon monoxide sensor to protect occupants from fire that may be further connected to an intrusion sensor 765 on window 120 or entry door 770 to set the alarm off in case of unwanted intrusion. Security/fire alarm 660 may be controlled by remote controller 775 to trigger alarm 660 in case of attack, silence it in case of false alarms, or test its operation. In grid-dependent shelters, dwelling security alarms are large expensive distributed devices, while the present embodiment many be implemented for off-grid shelter applications via slight modification to the circuitry of a very low-cost mass-market smoke alarm.

Off-Grid Home-Scale Water Subsystem

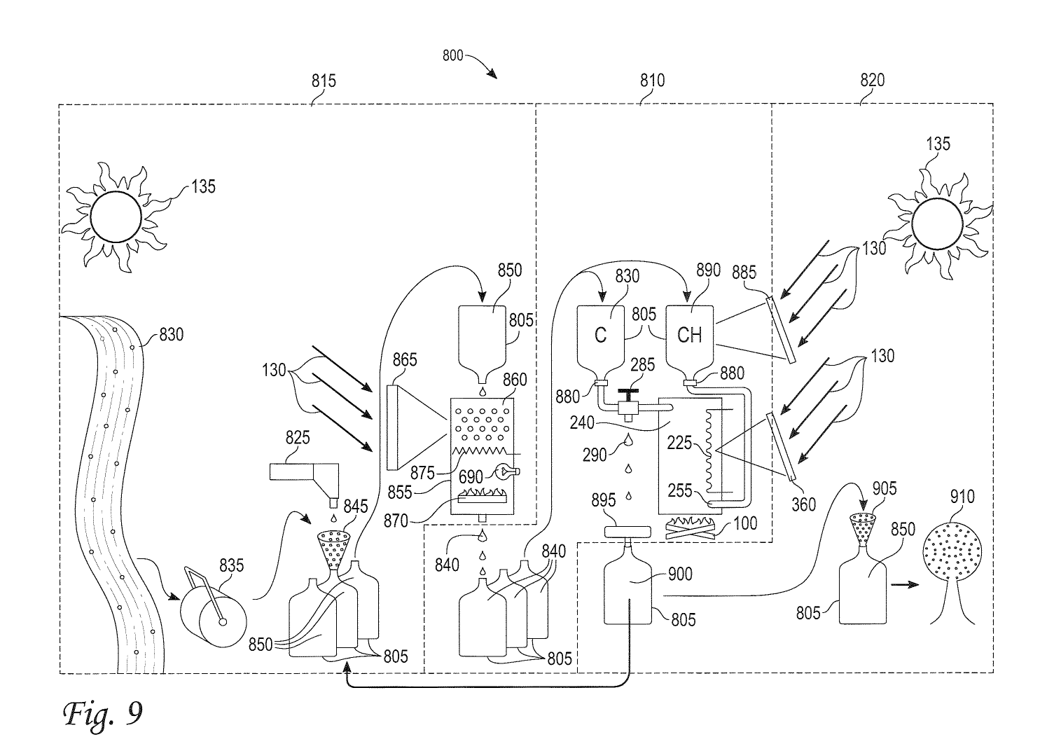

FIG. 9 illustrates a complete off-grid water subsystem 800 that provides water functions including collection, transport, storage, purification, heating, dispensing, and recycling. Standardized water containers 805 such as (in the US) 5 gallon water bottles are mass produced for commercial water deliveries, and may be delivered full to a disaster area in large quantities to supply initial water needs, then reused in the present water system. Important aspects of the water subsystem such as heating, cooling, and dispensing have been previously described, and FIG. 9 omits many previously described details while illustrating water subsystem 800 in an end-to-end fashion.

In FIG. 9, off-grid home-scale water subsystem 800 is divided into clean area 810 and dirty areas 815 and 820. In clean area 810 all water is potable, while in dirty areas 815 and 820 it is not. Collected water in dirty area 815 is considered unusable until it is treated, and used grey water in dirty area 820 is also considered unusable until treated. The user uses separate water containers 805 for clean area 810, while water containers 805 may be comingled between dirty areas 815 and 820.

Water subsystem 800 begins with collection, which may be accomplished in at least three ways presuming a well or water utility grid is unavailable. First and generally easiest, rainwater may be collected by a rain catchment 825 such as gutters and downspouts, which drain to water containers 805. A small shelter 2 (FIG. 1) with 170 sq ft under roof can collect 100 gallons from 1″ of rain in this manner, sufficient for a family of four to survive a month. Second, if no rain is available, a nearby water source 830 such as a river may be used to collect dirty water into water containers 805. Water transporter 835 will be later described to enable human-powered transport of water containers 805 over long distances. Third, water containers 805 may be delivered by an aid provider, and may be used or stored directly as purified water 840.

Water collected from rain catchment 825 and local water sources 830 is poured through a pre-filter 845 to remove particulate matter including leaves and insects. Water containers 805 containing pre-filtered water 850 are then poured into water purifier 855. Water purifier 855 may utilize one or more known techniques to purify and sanitize water, including sand filter 860, heat pasteurization using solar heater 865 or other heat sources 870 as previously described, distiller 875, UV LED sanitizer 690, and/or other means.

In one embodiment of water purifier 855, sand filtration 860 would be followed by selection between LED sanitizer 690 and integrated heating using solar heater 865 and other heat sources 870. Such an embodiment could be achieved using the means described for off-grid thermal appliance 400 to pasteurize or distill water based on the configuration of FIG. 4A or FIG. 6. In a distiller embodiment, a heat exchanger 445 as shown in FIG. 4A would heat water to boiling, and then release boiling water or steam through an interconnect 465. Such distilled or pasteurized water could either proceed to hot water tank 240, or steam would condense into a water container 805 containing purified water 840, or boiling water could be forced into a water container 805 containing purified water 840 via pressure caused by downflowing pre-filtered water 850 instead of pressure from cold tank 830 as described in FIG. 2B. Off-grid thermal appliance 400 may be modified at extremely low cost and complexity in this manner to add a distiller 875 or pasteurizing treatment that delivers key functionality to water purifier 855.

In clean area 810, water purifier 855 outputs purified water 840 into water containers 805. A water container 805 containing purified water 840 may be used as cold tank 830 within cold chamber 235 (FIG. 2A) by opening water container 805 containing purified water 840 and placing it upside down into gravity dispenser 880, that feeds water whenever pressure below it is reduced by opening tap 285 to release temperate water 290. Hot water to mix with the cold water in the tap may be fed from hot tank 240, heated via any combination of solar radiation 130 captured by solar concentrator 360 to heat exchanger 225, or open fire 100, or other fueled heat sources as described in FIGS. 2A, 4A, 6, or 8.

Clean area 810 shows an additional improvement wherein a water container 805 from clean area 815 may be used within a preheater 885 to generate preheated water 890 for gravity feeding into hot tank 240. In the embodiment of FIG. 9, water being heated by preheater 885 is used to drive the gravity feed for hot tank 240 in the manner cold tank 230 provided that function in FIG. 2A. This enables preheater 885 to be placed on the roof 5 of a shelter 2, and implemented as a simple solar collector 360 that generates preheated water 890, which flows via gravity dispenser 880 to hot tank 240 via hot tank inlet 255 to pressurize hot tank 240. In addition, where heat is used to pasteurize or distill water, heat retained in such purified water 840 may be scavenged by immediately placing a water container with heated purified water 840 into preheater 885, or by placing the heated water container 805 within shelter 2. It is noted that while hot tank 240 may be made out of a standard water container 805, a standard water container 805 is not shown as hot tank 240 in FIG. 9 since standard water containers tend to have one opening at the top, while hot tank 240 comprises connections at top and bottom for the convective flow and gravity feed as detailed in FIG. 2A. As may be appreciated, a standard water container 805 may be readily modified to serve as hot tank 240. Alternatively, a standard water container 805 may be configured with a heat exchanger 225 via its single opening, or a pair of standard containers 805 may be used with a heat exchanger between them.

As temperate water 290 is dispensed from tap 285, used, and drained into a drain 895 that may be part of a sink or shower stall, the used gray water 900 is collected into another water container 805 in a dirty area 820. Gray water 900 may be poured through a pre-filter 845 to remove particulates and then used for purposes such as growing food 910. If water scarcity is extreme, gray water 900 may be poured directly through pre-filter 845 for re-purification and reuse. To the extent particulates collected by pre-filter 845 and post-filter 905 contain organic matter, such matter may often be desiccated and then used as fuel.

For black-water generated at composting potty 590 (not shown in FIG. 9), urine is separated from solid waste using a bifurcated seat or by draining from the composting tank. The urine containing nitrogen, phosphorous, and potassium may be used as fertilizer for food gardening, or for algae gardening to process into bio-fuel. The solid waste similarly becomes a soil amendment after aerobic composting through thermophilic decomposition, using heat and ventilation from the previously described subsystems. By using such bio-fuel in combination with solar radiation to power off-grid thermal appliance 400, a user can achieve minimal carbon and other footprints, by removing carbon from the atmosphere to grow food and algae for fuel, plus recycling human waste to fertilize them.

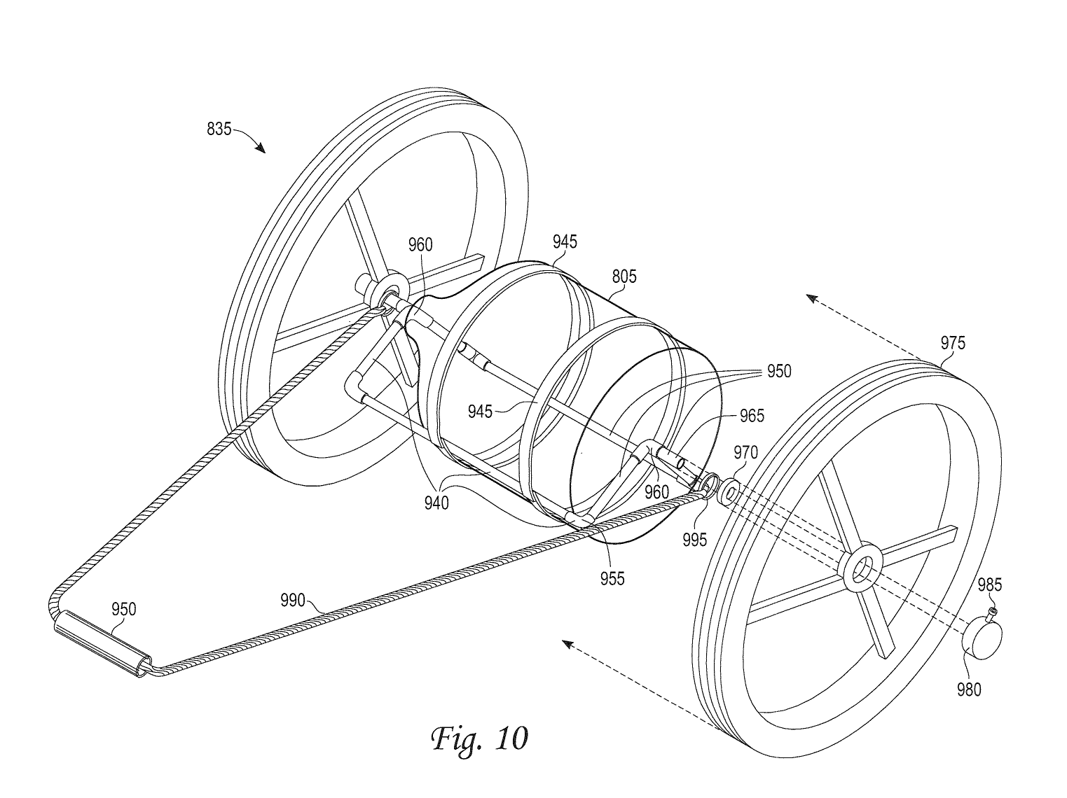

In cases where local water sources 830 are used to collect water, it is possible that the collected water must be transported a significant distance. Such water transport is a significant physical challenge for hundreds of millions in the developing world, and often keeps women from income producing work or education. To facilitate transport, FIG. 10 illustrates detail for enabling a simple but effective embodiment of water transporter 835 that may be produced locally by the poor or disaster victims.

In FIG. 10, standard water container 805 is held securely in cradle 940 by straps 945 such as ropes, or webbing with Velcro ends that may be detached for removal. Cradle 940 may be easily fabricated from PVC plumbing parts or equivalent, including eight straight tubes 950, four 90 degree elbows 955, and two three-way corner connections 960. The two tubes at the ends of cradle 940 form stationary axles 965 that insert through the inner race of wheel bearing 970 and lock to it, while bearing 970 contains wheel 975 connected around its outer race. Wheel 975 is then held onto axle via the inner race of bearing 970 using any simple means such as a pipe cap 980 and retaining screw 985, cotter pin, or clip. To facilitate towing by a human, draft animal, or bicycle, tow rope 990 containing axle rings 995 apply pulling force to axles 965, and an additional piece of straight tube 950 may be inserted around rope 990 as a handle. As long as the center of gravity of water container 805 and the water within it remains below an imaginary line connecting axles 965, cradle 940 will remain stably below water container 805 whenever cradle 940 is pulled by tow rope 990.

In one embodiment of water transporter 835, old bicycle wheels are used as wheel 975. When both of wheels 975 including their bearings 970 are removed from water transporter 835, the wheels may be attached to a straight axle and used to form the basis of a cart for transporting goods. Such a cart may be used to transport lightweight foldable building structures, enabling a folding shelter as well as the entire family scale utility grid to be transported using wheels 975. This can be a critical advantage in disaster relief, as well as refugee situations where permanency is discouraged.

When water transporter 835 is used within off-grid water subsystem 800, a complete end-to-end family-scale post-disaster water infrastructure is enabled that duplicates on minimalist scale all of the functions of city-scale water utilities. Analogously, integrating water subsystem 800 with previously described subsystems passive room and cooking ventilator 1, turbine solar chimney trombe 170, off-grid thermal appliance 400, integrated cooking, heating, and ventilation subsystem 530, and/or integrated electrical subsystem 650 enables complete integration of family-scale thermal, water, power, and waste utility subsystems.

The various systems and methods described herein enable survival and comfort as well as a developing world version of prosperity, by significantly reducing fuel and water expenses while enabling productive work at night and in bad weather. It enables such potentially transformative lifestyles via sustainable production that requires non-local, rare, or expensive materials only within the solar cell 715, battery 725, and generator 600, while essentially all other components may be made from waste or recycled materials. These systems consume a small fraction of the fossil fuels or other flammable carbon resources that would otherwise be required, and limit total ongoing ecological impact of a family to extremely small carbon, global warming, and other footprints from combustion or any other sources.

Having described and illustrated the principles of the preferred embodiments, it should be apparent that the embodiments may be modified in arrangement and detail without departing from such principles. Claim is made to all modifications and variation coming within the spirit and scope of the following claims:

1. A water processing system comprising:
a water collector configured to deliver unpurified water to a first container;
a water purifier configured to purify the water in a second container; and
a thermal scavenging device configured to extract heat from a thermal source to heat the purified water, wherein the heated water is stored in a third container, and wherein the first, second, and third containers comprise identically sized containers.

2. The system according to claim 1, wherein the thermal source comprise a cooking device, and wherein the thermal scavenging device comprises a heat exchanger configured to extract heat from the cooking device.

3. The system according to claim 1, wherein the thermal scavenging device comprises a heat exchanger configured to extract heat from a solar ventilator.

4. The system according to claim 1, further comprising a rechargeable battery, wherein the thermal scavenging device comprises an electrical heater configured to receive electricity when the battery is unable to accept a charge.

5. The system according to claim 4, wherein the thermal source comprises a solar collector configured to charge the battery.

6. The system according to claim 4, further comprising a wind-powered turbine mounted on a building structure, wherein a rotation of the turbine is configured to charge the battery.

7. The system according to claim 6, wherein the wind-powered turbine is further configured to circulate evaporated water through the building structure.

8. The system according to claim 1, further comprising a wind-powered turbine mounted on a building structure, wherein the thermal source comprises a solar collector, and wherein the wind-powered turbine is configured to circulate solar heat through the building structure.

9. The system according to claim 8, wherein the thermal scavenging device comprises a heat exchanger thermally coupled to the third container, and wherein the solar collector is configured to concentrate solar heat on the heat exchanger.

10. The system according to claim 1, further comprising a flue configured to capture heat from the thermal source, wherein the thermal scavenging device comprises a heat exchanger in thermal contact with the flue.

11. The system according to claim 1, wherein the thermal scavenging device comprises:
a heat exchanger fluidly coupled to the third container and located within the thermal device; and
a valve configured to select between a first fluid path including water contained with the heat exchanger that remains within the thermal device and a second fluid path including water that circulates through the heat exchanger into the third container.

12. The system according to claim 11, wherein the water circulates through the heat exchanger via convection.

13. The system according to claim 11, wherein the water in the second fluid path circulates from the second container into the third container, and wherein water in the third container is maintained at a higher temperature than water in the second container.

14. The system according to claim 1, wherein the water collector is configured to recycle water dispensed from the third container by delivering the dispensed water to the first container.

15. The system according to claim 1, wherein the water collector comprises means for collecting rain water.

16. The system according to claim 1, wherein the water purifier comprises a filter configured to separate solid waste from liquid waste, wherein the liquid waste is stored in a fourth identically sized container.

17. The system according to claim 1, wherein the water purifier is configured to heat the water with heat extracted by the thermal scavenging device.

18. A method comprising:
collecting unpurified water in a first container;
purifying the water in a second container; and
extracting heat from a thermal source to heat the purified water in a third container, wherein the first, second, and third containers comprise identically sized containers.

19. The method according to claim 18, wherein the thermal heat source includes an electric heater, and wherein the method further comprises:
charging a battery by converting wind or solar power into electricity; and
directing the electricity to the electrical heater when the battery is fully charged.

20. The method according to claim 18, wherein the electricity is generated from a rotation of a wind-powered turbine located on a building structure, and wherein the building structure houses one or more of the identically sized containers.

21. The method according to claim 18, wherein the heat is extracted by a heat exchanger thermally coupled to the third container, and wherein the method further comprises concentrating solar heat on the heat exchanger.

22. The method according to claim 21, further comprising circulating water from the heat exchanger to the third container through natural convection.

23. The method according to claim 22, further comprising drawing water from the second container to the third container through gravity.

24. The method according to claim 21, wherein the thermal source comprises thermal combustion, wherein the method further comprises capturing exhaust from the thermal combustion, and wherein the heat exchanger is in thermal contact with the exhaust.

25. The method according to claim 18, further comprising separating solid waste from liquid waste, wherein the liquid waste is stored in a fourth identically sized container.

26. The method according to claim 25, wherein the solid waste is separated from the unpurified water of the first container.
